(19) United States
(12) Patent Application Publication
(10) Pub. No.: US 2024/0386314 A1
(43) Pub. Date: Nov. 21, 2024

(54) APPARATUSES, METHODS, AND COMPUTER PROGRAM PRODUCTS FOR TRAINING AND USING MACHINE LEARNING MODELS IN SPARSE DATA ENVIRONMENTS USING TRANSFORMED DATA SETS

(71) Applicant: Honeywell International Inc., Charlotte, NC (US)

(72) Inventors: Mitchell O'Brien, Tempe, AZ (US); Andrew Harper, Atlanta, GA (US); Himadri S. Pal, Sugar Land, TX (US); Xiaoxiang Ma, Atlanta, GA (US)

(21) Appl. No.: 18/318,411

(22) Filed: May 16, 2023

(51) Int. Cl. G06N 20/00; G06N 5/022

(52) U.S. Cl. CPC G06N 20/00; G06N 5/022

(57) ABSTRACT

Methods, apparatuses, and computer program products for generating predictions using machine learning model(s) are provided. For example, a computer-implemented method may include receiving raw historical data identifying historical value(s) corresponding to attribute value(s) of a set of ordered attribute values and transforming the raw historical data into parameter expanded data by, for each particular attribute value of the set of ordered attribute values, aggregating each of the historical value(s) that corresponds to the particular attribute value and each of the historical value(s) that corresponds to an attribute value that is greater than the particular attribute value. The machine learning model(s) are trained based on the parameter expanded data, which trained machine learning model(s) are used to generate the predictions.

### TECHNICAL FIELD

Embodiments of the present disclosure generally relate to machine learning models, and specifically to training and using machine learning models to generate predictions.

### BACKGROUND

Applicant has identified many technical challenges and difficulties associated with current solutions for training and using machine learning models to generate predictions. Through applied effort, ingenuity, and innovation, Applicant has solved problems relating to training and using machine learning models to generate predictions, which are described in detail below.

### BRIEF SUMMARY

According to one aspect, embodiments of the present invention feature an apparatus comprising at least one processor and at least one non-transitory memory comprising program code stored thereon. The at least one non-transitory memory and the program code are configured to, with the at least one processor, cause the apparatus to at least: receive raw historical data identifying at least one historical value corresponding to at least one attribute value of a set of ordered attribute values, wherein the set of ordered attribute values corresponds to a selected attribute; transform the raw historical data into parameter expanded data corresponding to the selected attribute, wherein the parameter expanded data is associated with a prediction task to be performed via at least one machine learning model and comprises aggregated data associated with at least a subset of the set of ordered attribute values, by at least: for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value; train the at least one machine learning model based at least in part on the parameter expanded data; and generate output data corresponding to the prediction task using the trained at least one machine learning model.

In some embodiments, the at least one non-transitory memory and the program code are configured to, with the at least one processor, further cause the apparatus to at least cause performance of at least one enterprise management operation based at least in part on the generated output data.

In some embodiments, the at least one non-transitory memory and the program code are configured to, with the at least one processor, further cause the apparatus to at least cause rendering of a results interface that presents the generated output data. In some examples, the results interface may present the output data with respect to a plurality of objects based at least in part on, for each particular object of the plurality of objects, a determined mismatch between a current parameter value associated with the particular object corresponding to the selected attribute and a corresponding predicted value associated with the particular object in the output data corresponding to the selected attribute and/or a level of confidence associated with an instance of the parameter expanded data corresponding to the particular object.

In some embodiments, training the at least one machine learning model based at least in part on the parameter expanded data comprises generating a pseudo-curve model that represents the parameter expanded data and training the at least one machine learning model based at least in part on the pseudo-curve model. In some examples, an elasticity model expressing elasticity output values (e.g., included in the output data) with respect to input values corresponding to the selected attribute and/or a shifter model expressing shifted output values (e.g., included in the output data) with respect to input values corresponding to the selected attribute and with respect to at least one additional variable may be generated and trained based at least in part on the pseudo-curve model.

In some embodiments, generating the output data corresponding to the prediction task comprises performing at least one optimization operations using at least one optimization algorithm with respect to at least a portion of the output data generated from the trained at least one machine learning model, with results of the at least one optimization operation being included in the output data.

In some embodiments, the selected attribute represents a price attribute, each historical value of the at least one historical value represents a determined demand value corresponding to a particular price value represented by the corresponding attribute value, the parameter expanded data comprises an aggregation of demand at a given price and all prices greater than the given price, and the output data represents predicted demand, predicted elasticity, and/or determined optimal pricing based on a pseudo-demand model determined based at least in part on the parameter expanded data.

According to another aspect, embodiments of the present invention feature a method comprising receiving raw historical data identifying at least one historical value corresponding to at least one attribute value of a set of ordered attribute values, wherein the set of ordered attribute values corresponds to a selected attribute; transforming the raw historical data into parameter expanded data corresponding to the selected attribute, wherein the parameter expanded data is associated with a prediction task to be performed via at least one machine learning model and comprises aggregated data associated with at least a subset of the set of ordered attribute values, by at least: for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value; training the at least one machine learning model based at least in part on the parameter expanded data; and generating output data corresponding to the prediction task using the trained at least one machine learning model.

According to another aspect, embodiments of the present invention feature a computer program product comprising at least one non-transitory computer-readable storage medium having computer-readable program code portions stored therein. The computer-readable program code portions comprise an executable portion configured to: receive raw historical data identifying at least one historical value corresponding to at least one attribute value of a set of ordered attribute values, wherein the set of ordered attribute values corresponds to a selected attribute; transform the raw historical data into parameter expanded data corresponding to the selected attribute, wherein the parameter expanded data is associated with a prediction task to be performed via at least one machine learning model and comprises aggregated data associated with at least a subset of the set of ordered attribute values, by at least: for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value; train the at least one machine learning model based at least in part on the parameter expanded data; and generate output data corresponding to the prediction task using the trained at least one machine learning model.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an example data expansion and prediction system, in accordance with at least some example embodiments of the present disclosure;

FIG. 4 is an illustration of an exemplary prediction dashboard screen of a graphical user interface, in accordance with at least some example embodiments of the present disclosure;

FIG. 5 is an illustration of an exemplary prediction details screen of a graphical user interface, in accordance with at least some example embodiments of the present disclosure;

FIG. 6 illustrates a flowchart including operational blocks of an example process for transforming raw historical data to parameter expanded data and generating predictions based on the transformed data, in accordance with at least some example embodiments of the present disclosure; and

FIG. 7 illustrates a flowchart including operational blocks of an example process for creating a pseudo-curve model based on the transformed raw historical data and generating predictions using the pseudo-curve model, in accordance with at least some example embodiments of the present disclosure.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

In some exemplary scenarios, enterprises such as businesses or other organizations may provide products such as goods or services of various types. Often, enterprises will maintain historical data associated with provision of these products, and, for a variety of reasons, these enterprises may need to analyze the historical data to determine and/or set various production parameters that determine various aspects of how the enterprises operate and/or how these products are produced and/or distributed. In one example, product managers may be responsible for setting such parameters with respect to particular products such as prices, sales, distribution, vendor, and/or supplier agreement terms, marketing and/or advertising budgets and/or bids, and/or production goals and/or budgets, to list a few examples. More generally, analysis of the historical data maintained by an enterprise may result in insights of various types into any of the enterprise's operations.

Enterprise management systems, such as enterprise performance management (EPM) systems, have been proposed. These systems may provide visibility into and/or perform various control operations with respect to various types of enterprise systems maintained by an enterprise, various types of production operations performed by and/or associated with the enterprise in connection with provision of products by the enterprise, and/or various types of transactions, communications, agreements, campaigns, and/or distribution operations performed by and/or associated with the enterprise in connection with provision of products by the enterprise. In one example, these systems may be configured to provide, for each enterprise, an enterprise-wide, top-to-bottom, historical and/or real-time view of the status of various products, processes, production operations, assets, entities, objects, agreement terms, transactions, communications, budgets, objectives, market conditions, performance metrics, and/or any other aspect associated with the provision of products by the enterprise. These systems can be used to generate insights (e.g., predictions and/or recommendations) for optimizing various aspects of provision of the products, including insights concerning past performance, optimization of parameters with respect to current production and/or marketing operations, and/or predictions concerning future performance and/or market conditions, to list a few examples. In some cases, enterprise management systems may generate and present the insights, for example, by aggregating from various internal and/or external sources (e.g., historical) data associated with production operations of an enterprise, performing various analysis operations with respect to the aggregated data, and/or visually presenting the aggregated data and/or any data derived therefrom (e.g., via the analysis operations). Additionally, an enterprise management system may be configured to effect changes to various production parameters based on the generated and/or presented insights. These insights are often generated using machine learning models, which may be developed, configured, and/or trained (e.g., by and/or within the enterprise management systems) using one or more machine learning algorithms.

However, in many cases, the types of predictions and usefulness of predictions that can be generated by an enterprise management system depends upon the quality of the data that is available to the enterprise management system. Thus, a sparse data environment underlying a product, operation, campaign, and/or objective can hinder the usefulness of enterprise management systems in generating insights with respect to that product, operation, campaign, and/or objective. In such a sparse data environment, for example, data may have characteristics (e.g., amount of data, historical depth, breadth, variety of features, variety of historical scenarios represented) that make it difficult and impractical, if not impossible, to generate useful insights using the data. In one example, a sparse data environment may be a result of certain types of historical data generated with respect to production operations performed by an enterprise being relatively difficult to aggregate due to factors such as a lack of standardized recording of such data, inconsistent and/or decentralized storage of the data, issues with gaining authorization to access the data, and/or various regulatory and/or legal requirements concerning the data, to list a few examples. In another example, certain types of products may tend to result in a sparse data environment in certain contexts.

For the purpose of illustration in one example domain, for example, certain types of products such as those related to the aerospace industry (e.g., parts and/or components of aerospace systems such as aircraft) may tend to be purchased in high quantities all at once for a certain unit price as opposed to over the course of several transactions with prices that vary (e.g., based on fluctuations from transaction to transaction in demand or other market conditions), resulting in sparse raw historical data (e.g., transaction data) that does not cover a variety of unique unit prices sufficient for generating certain types of insights such as those concerning elasticity and/or how changes in price impact other aspects of a product's production such as demand. As a result, training and using a machine learning model to generate such insights with respect to these products with sparse data environments has been difficult if not impossible. For example, in some scenarios, raw historical data comprising a sparse representation of different unit prices might result in a machine learning model incorrectly learning that lower prices for a product tend to result in lower demand for that product.

In various embodiments, the presently disclosed data expansion and prediction system enables a machine learning model to be configured and/or trained to generate useful and accurate predictions even in the face of a sparse data environment by transforming raw historical data to parameter expanded data, training one or more machine learning models corresponding to a prediction task using the parameter expanded data, and generating output data (e.g., predictions) using the trained machine learning model(s). In one embodiment, the system may be configured to transform the raw historical data in a particular manner and/or to train machine learning model(s) particularly configured according to a known context associated with the raw historical data and/or any prediction tasks performed based on such data. For example, transforming the raw historical data to the parameter expanded data may comprise performing a temporal aggregation with respect to various items reflected in the raw historical data by virtue of the underlying context inviting an assumption that historical values associated with a particular attribute value may logically comprise an aggregation of all historical values associated with a greater attribute value or a lower attribute value. In this case, the transformation of the raw historical data may comprise defining, in the parameter expanded data, a historical value for every possible attribute value (e.g., of a predefined set of attribute values) as the sum of all of the historical values associated with greater or lower attribute values in the raw historical data. For the purpose of illustration, in one example scenario, raw historical data comprising transactions indicating a demand or quantity of units purchased at various price points may be transformed into parameter expanded data in which the demand at every possible price point (including those price points beyond merely those reflected in the historical data) is defined as the sum of demand at all higher price points. This transformation, based on an assumption that for any given historical transaction at a certain price point for a certain quantity a purchaser would also have been willing to purchase at least that same quantity at any lower price point, provides an efficient, non-resource-intensive, cost-effective way of training a machine learning model to generate any predictions that may be premised upon such an assumption, including predicted demand at given price points and/or predicted elasticity, to list a few examples. In this way, for example, the presently disclosed system provides an improvement to the functioning of a computer and to machine learning systems, among other benefits.

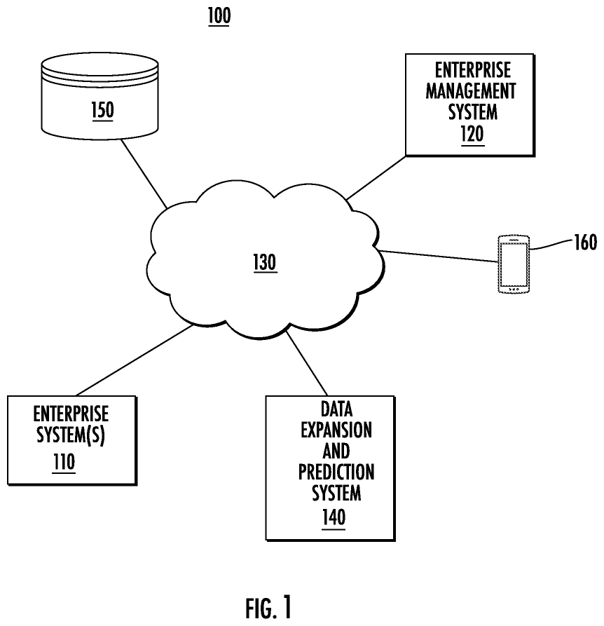

FIG. 1 illustrates an exemplary block diagram of an environment 100 in which embodiments of the present disclosure may operate. Specifically, FIG. 1 illustrates one or more enterprise systems 110, a data expansion and prediction system 140, an enterprise management system 120, one or more data repositories 150, and one or more user devices 160, all connected to a network 130.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The one or more data repositories 150 may be configured to receive, store, and/or transmit data. In some embodiments, the one or more data repositories 150 may be configured to store enterprise data, including any data and/or metadata associated with one or more enterprises, one or more products provided by the enterprise(s), one or more enterprise systems 110 associated with provision of the product(s), one or more production, marketing, and/or distribution operations associated with provision of the product(s), and/or any raw and/or transformed historical data (e.g., transaction data) generated and/or otherwise stored with respect to the enterprise(s), product(s), system(s) 110, and/or operation(s). In some embodiments, the one or more data repositories 150 may be configured to store data and/or metadata associated with and/or defining machine learning models corresponding to various prediction tasks, including any trained instances of the machine learning models associated with particular product(s) (e.g., trained model metadata, trained model artifacts, parameters, hyperparameters, training data sets, and/or data indicative thereof), one or more instances of parameter expanded data (e.g., generated by transforming data from the enterprise data) used for training the machine learning model(s), any input data used by the trained machine learning model(s), any output data produced by the trained machine learning model(s), and/or any data derived from any of the output data, for example, as a result of performing various calculations, transformations, analyses, combinations, selections, and/or optimization operations with respect to the output data.

The one or more user devices 160 may be associated with and/or operated by users of the enterprise management system 120, the data expansion and prediction system 140, and/or any of the enterprise system(s) 110. In various embodiments, the enterprise management system 120 and/or the data expansion and prediction system 140 may cause enterprise data, output data generated using machine learning model(s), and/or any data derived therefrom to be transmitted to and/or displayed on the user device(s) 160, for example.

The one or more enterprise systems 110 may refer to systems of any type maintained by and/or associated with one or more enterprises, including any systems configured to perform and/or facilitate performance of production and/or distribution operations associated with the enterprise in connection with provision of products by the enterprise and/or to define, maintain, effect, track, organize, monitor, and/or audit various types of transactions, communications, agreements, campaigns, budgets, strategies, and/or objectives associated with the enterprise in connection with provision of products by the enterprise. In some embodiments, the enterprise system(s) 110 may include one or more computer, software, and/or network systems, including one or more enterprise networks (e.g., comprising user devices, server devices, and/or networking devices connected to each other via one or more networks), one or more cloud-based or on-site, centralized and/or distributed software systems, customer relationship software systems, sales management software systems, product management software systems, project management software systems, price management systems, collaboration platforms, human resource management software systems, accounting and/or payroll software systems, content management systems, content (e.g., web content) server systems, e-commerce software systems, document management systems, contract management systems, marketing software systems, inventory management systems, point-of-sale systems, quality management systems, distributed and/or centralized transaction ledger systems, and/or any systems associated with internal and/or external processes and/or operations of an enterprise, to list a few examples. In some embodiments, the enterprise system(s) 110 may include one or more operational systems, including mechanical and/or electronic manufacturing, material handling, distribution, sorting, automation, and/or environment monitoring and control systems, to list a few examples.

The data expansion and prediction system 140 may be a computing system or device (e.g., server system) configured via hardware, software, firmware, and/or a combination thereof, to perform data expansion and prediction generation functionality, comprising, for example, transforming raw historical data into parameter expanded data, training machine learning model(s) based on the parameter expanded data, generating output data (e.g., comprising predictions) using the trained machine learning model(s), storing the output data, rendering a results interface configured to present the output data and/or any data derived therefrom, and/or causing the enterprise management system 120 to perform enterprise management operations with respect to the enterprise system(s) 110 based on the output data, to list a few examples. In some embodiments, the data expansion and prediction system 140 may be a sub-system of and/or otherwise integrated with the enterprise management system 120. In some embodiments, the data expansion and prediction system 140 may be a standalone system in communication with the enterprise management system 120 (e.g., via the network 130).

The enterprise management system 120 may be or comprise an enterprise management system or EPM system as previously defined and described and/or may be or comprise a computing system or device (e.g., server system) configured via hardware, software, firmware, and/or a combination thereof, to perform various operations with respect to the enterprise system(s) 110, aggregated enterprise data, output data generated via the data expansion and prediction system 140 and/or any other machine learning systems, comprising, for example, presenting interface(s) configured to receive input used in performance of the enterprise management operations, receiving (e.g., via the presented interface(s)) the input, accessing and/or retrieving the aggregated enterprise data and/or output data and/or any data derived therefrom via any calculations, transformations, analyses, combinations, and/or selections performed with respect to the retrieved and/or accessed data, presenting some or all of the accessed, retrieved, and/or derived data, and/or performing monitoring and control operations with respect to the enterprise system(s) 110 based at least in part on the retrieved, accessed, and/or derived data.

In some embodiments, the enterprise management system 120 may be configured to present and/or process any output data resulting from operations performed by the data expansion and prediction system 140 and/or the enterprise system(s) 110, including, for example, presenting one or more monitoring, control, and/or insight interfaces within a graphical user interface (GUI) rendered on one or more displays of one or more of the user devices 160. The one or more interfaces may comprise one or more graphical elements for displaying the output data (e.g., including data resulting from processing the output data) and/or one or more interactable elements for receiving presentation and/or analysis input, for example, as user input. The presentation and/or analysis input may represent one or more selections of presentation parameters for determining how the output data is displayed and/or one or more selections of analysis parameters for determining how the output data is processed, to name a few examples.

While FIG. 1 illustrates certain components as separate, standalone entities communicating over the network 130, various embodiments are not limited to this configuration. In other embodiments, one or more components may be directly connected and/or share hardware or the like.

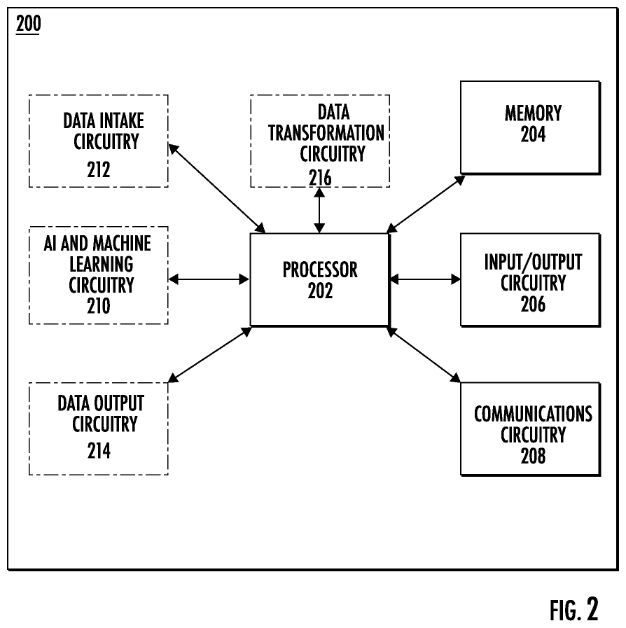

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, one or more components of the operational system(s) 110, a data expansion and prediction system 140, an enterprise management system 120, data repositories 150, and/or user devices 160. The apparatus 200 includes processor 202, memory 204, input/output circuitry 206, communications circuitry 208, and/or data intake circuitry 212, artificial intelligence (AI) and machine learning circuitry 212, data output circuitry 214, and/or data transformation circuitry 216. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, a device, system, or apparatus, such as apparatus 200 of the operational system(s) 110, a data expansion and prediction system 140, an enterprise management system 120, data repositories 150, and/or user devices 160, may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry embodying the memory 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Data intake circuitry 212 may be included in the apparatus 200. The data intake circuitry 212 may include hardware, software, firmware, and/or a combination thereof, designed and/or configured to request, receive, process, generate, and transmit data, data structures, control signals, and electronic information for capturing, receiving, requesting, and/or otherwise gathering aggregated enterprise data from internal and/or external sources, including performing any of the operations described herein with respect to aggregating and/or storing any system data (e.g., of the enterprise system(s) 110), external data, and/or raw historical data of the aggregated enterprise data.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training a machine learning model and executing a trained machine learning model according to the operations and/or functionalities described herein. For example, in some embodiments the AI and machine learning circuitry 210 includes hardware, software, firmware, and/or a combination thereof, that identifies training data and/or utilizes such training data for training a particular machine learning model, model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

Data transformation circuitry 216 may be included in the apparatus 200 (e.g., an apparatus specifically corresponding to the data expansion and prediction system 140). The data transformation circuitry 216 may include hardware, software, firmware, and/or a combination thereof, designed and/or configured to request, receive, process, generate, and transmit data, data structures, control signals, and electronic information for transforming raw historical data, including performing any of the operations described herein with respect to receiving raw historical data and/or transforming the raw historical data into parameter expanded data.

In some embodiments, two or more of the sets of circuitries 202-216 are combinable. Alternatively, or additionally, one or more of the sets of circuitry 202-216 perform some or all of the operations and/or functionality described herein as being associated with another circuitry. In some embodiments, two or more of the sets of circuitry 202-216 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

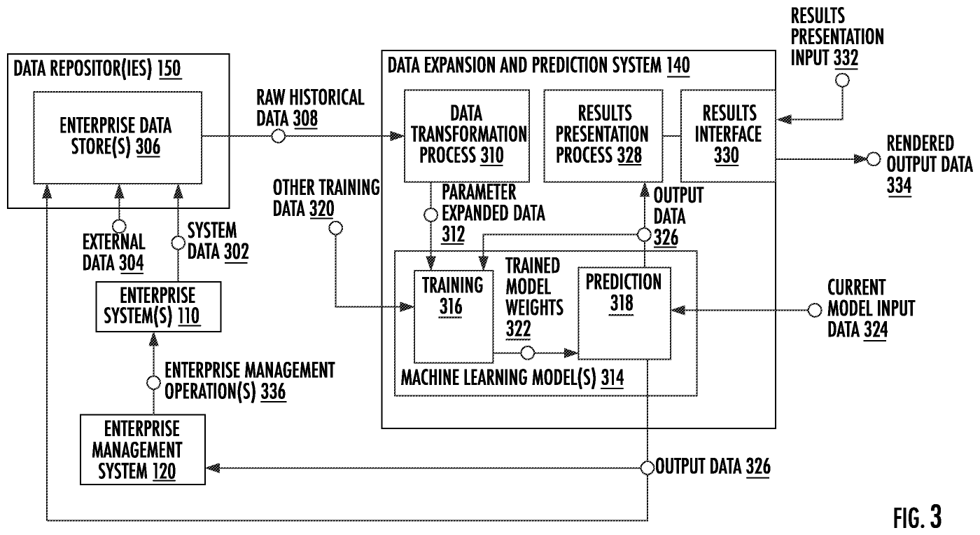

FIG. 3 is an illustration of an example data expansion and prediction system 140, in accordance with at least some example embodiments of the present disclosure. Specifically, FIG. 3 includes schematic depictions of the example data expansion and prediction system 140, including example internal processes and components of the data expansion and prediction system 140, and/or schematic depictions of the one or more data repositories 150, the enterprise management system 120, and the enterprise system(s) 110 in communication with the data expansion and prediction system 140, along with example data objects used by and/or produced by the depicted processes, components, and/or systems. The data expansion and prediction system 140 and/or apparatuses 200 associated therewith, for example, may be specially configured via hardware, software, firmware, and/or a combination thereof, to perform the various data processing and interactions described with respect to FIG. 3 to perform historical data transformation operations with respect to raw historical data, machine learning model training operations with respect to the transformed raw historical data, and/or prediction generation operations using trained machine learning models.

In the illustrated example, the data expansion and prediction system 140 comprises hardware, software, firmware, and/or a combination thereof configured to perform functionality attributed to each of a data transformation process 310, a training process 316 and prediction process 318 corresponding to one or more machine learning models 314, a results presentation process 328, and a results interface 330. Additionally, the one or more data repositories 150 comprise, in some examples, one or more enterprise data stores 306 associated with the enterprise management system 120 and/or the data expansion and prediction system 140 and configured to store various types of aggregated enterprise data associated with enterprise(s) managed via the enterprise management system 120.

As previously mentioned, an enterprise with which the data expansion and prediction system 140 and/or enterprise management system 120 is associated may generate, collect, and/or accumulate a body of enterprise data, including any data and/or metadata associated with one or more enterprises, one or more products provided by the enterprise(s), one or more enterprise systems 110 associated with provision of the product(s), one or more production, marketing, and/or distribution operations associated with provision of the product(s), and/or any raw and/or transformed historical data (e.g., transaction data) generated and/or otherwise stored with respect to the enterprise(s), product(s), system(s) 110, and/or operation(s). In one example, the enterprise management system 120 may be configured to aggregate, collect, retrieve, generate, capture, receive, request, and/or otherwise gather such enterprise data from, associated with, and/or relevant to the enterprise and/or the enterprise systems 110, including any internally generated data, system data 302, and/or external data 304, and to combine such aggregated enterprise data to form the aggregated enterprise data stored in the enterprise data store(s) 306.

In some embodiments, the aggregated enterprise data stored in the enterprise data store(s) 306 may comprise system data 302 from and/or associated with any number of the enterprise system(s) 110 and/or any data derived from the system data 302. For example, the system data 302 may include any data generated (e.g., by the respective enterprise system(s) 110, and/or by the enterprise management system 120) in connection with configuration, operation, and/or maintenance of the various enterprise system(s) 110. More particularly, in some examples, the system data 302 may comprise data associated with any computer, software, and/or network systems of the enterprise system(s) 110, including any data identifying, defining, characterizing, and/or associated with one or more physical or virtual objects pertaining to the computer, software, and/or network systems, any data generated by, generated within, generated in connection with, and/or received by such objects pertaining to the computer, software, and/or network systems, these objects possibly including equipment, devices, processes, operations, communications, knowledge, products, services, users, employees, customers, markets, campaigns, and/or performance associated with any or all of the various systems and internal or external processes and/or operations implemented, managed, and/or facilitated by said systems.

In some embodiments, the aggregated enterprise data stored in the enterprise data store(s) 306 may comprise external data 304 accessed, retrieved, collected, and/or received from one or more external sources of data, the external data 304 being associated with, related to, and/or useful for management of the various enterprise system(s) 110 and/or performance or management of the various internal or external processes and/or operations of the enterprise(s) with which the enterprise management system 120 is associated. The external data 304 may comprise data from public archives, databases, research indexes, text data collections or corpuses, to list a few examples.

In various embodiments, the aggregated enterprise data stored in the enterprise data store(s) 306 may comprise raw historical data 308. In some embodiments, the raw historical data 308 may identify one or more historical values corresponding to one or more attribute values. In some examples, the raw historical data 308 may comprise historical transaction data associated with distribution of one or more products provided by the enterprise(s) with which the enterprise management system 120 is associated. More particularly, the raw historical data may comprise transaction data defining various attributes characterizing one or more sales transactions that have been recorded (e.g., via the enterprise system(s) 110), the transaction(s) effecting sales of units of a product by the enterprise to one or more purchasing entities. In one example, transaction data of the raw historical data 308 may define one or more attribute values, each representing a price (e.g., unit price) at which a product was sold via one or more transactions, and one or more historical values, each representing a quantity of units of the product that was sold (via the one or more transactions) at each price represented by each attribute value.

In some embodiments, the enterprise system(s) 110 may generate transaction data identifying, characterizing, and/or describing transactions and/or one or more data values associated with the transactions and corresponding to one or more particular parameters that may be selected for processing (e.g., by the enterprise management system 120) using one or more models (e.g., including possibly the machine learning model(s) 314). The enterprise management system 120 may aggregate the transaction data from one or more transactions (e.g., as the aggregated enterprise data) for processing.

In some embodiments, each of the one or more attribute values defined by the raw historical data 308 may be from a set of ordered attribute values corresponding to a selected attribute, which may refer to any attribute of interest and/or any attribute that may be the subject of and/or related to one or more prediction tasks that a machine learning model may be configured to perform (e.g., an attribute to which an input value, independent variable, dependent variable, and/or output value of a machine learning model corresponds). For example, the set of ordered attribute values may represent a domain of all possible attribute values and/or may refer to all possible individual attribute values and/or a predetermined quantity of attribute values that is (e.g., evenly) distributed across the domain of all possible attribute values such that the predetermined quantity of attribute values constitutes a representative sample of the domain. The set of ordered attribute values may include attribute values corresponding to each of the particular attribute values defined in the raw historical data 308 along with possibly other attribute values that are not defined in the raw historical data 308 (by virtue of no events and/or transactions to which the other attribute values pertain having occurred within a period to which the raw historical data 308 corresponds and/or no items of data having the other attribute values having been recorded in the raw historical data 308) but are considered to be possible attribute values (e.g., that may occur in future periods) and/or attribute values of interest in the context of various analysis and/or modeling operations (e.g., for determining and setting optimal attribute values). For the purpose of illustration, in one example scenario, the set of ordered attribute values may refer to a set of possible unit prices at which a product could possibly be sold and may include and/or represent unit prices at which units of the product have already been sold in the past (e.g., as indicated in the raw historical data 308) along with unit prices at which units of the product could theoretically be sold in the future.

In some example scenarios, the raw historical data 308 may comprise transaction data aggregated from with respect to certain types of products such as those related to the aerospace industry (e.g., parts and/or components of aerospace systems such as aircraft), which products may tend to be purchased in high quantities all at once for a certain unit price as opposed to over the course of several transactions with prices that vary (e.g., based on fluctuations from transaction to transaction in demand or other market conditions). Moreover, the raw historical data 308 may represent only a limited subset of total transactions due to difficulties in aggregating certain types of transaction data. As a result, even when historical values from the raw historical data 308 (e.g., representing demand or quantities purchased) are aggregated from across several transactions, these historical values may only correspond to a limited number of attribute values (e.g., price values), which may result in sparse raw historical data (e.g., transaction data) that does not cover a variety of unique unit prices sufficient for generating certain types of insights such as those concerning elasticity and/or how changes in price impact other aspects of a product's production such as demand.

In various embodiments, the data transformation process 310 of the data expansion and prediction system 140 may be configured to receive the raw historical data 308 (e.g., retrieved and/or accessed from the aggregated enterprise data stored in the enterprise data store(s) 306) and to generate parameter expanded data 312 based at least in part on the raw historical data 308, for example, by transforming the raw historical data 308 into the parameter expanded data 312. More particularly, in one example, the data transformation process 310 may be configured to transform the raw historical data 308 into the parameter expanded data 312 by, for each particular attribute value of the set of ordered attribute values, aggregating each of the one or more historical values that corresponds to the particular attribute value and each of the one or more historical values that corresponds to an attribute value that is greater than the particular attribute value. Put another way, the data transformation process 310 may be configured to generate the parameter expanded data 312 to comprise each particular attribute value from the set of ordered attribute values and, corresponding to each particular attribute value, an aggregation (e.g., sum) of any historical values from the raw historical data 308 that correspond to an attribute value that is greater than or equal to the particular attribute value. In one example scenario, the raw historical data 308 comprising transaction data indicating a demand or quantity of units (e.g., of the historical values) purchased at various price points (e.g., of the attribute values) may be transformed into the parameter expanded data 312 in which the demand at every possible price point (e.g., of the set of ordered attribute values) is defined as the sum of demand at all equal or higher price points as indicated in the raw historical data 308. In some embodiments, the parameter expanded data 312 may be associated with a prediction task to be performed via the machine learning model(s) 314.

In this way, for example, transforming the raw historical data 308 into the parameter expanded data 312 resolves the issues caused by the sparse data environment by extending the number of usable instances of each data record, for example, beyond simply a literal representation of historical values arising from a limited set of past occurrences (e.g., transactions at particular, specified attribute value) to an extended, extrapolated representation of the data with respect to a number of additional attribute values.

In various embodiments, the data expansion and prediction system 140 may be configured to generate output data 326 (e.g., using the machine learning model(s) 314), which may comprise, for example, one or more predictions corresponding to prediction tasks that the machine learning model(s) 314 are configured to perform along with possibly data derived therefrom as a result of performing various calculations, transformations, analyses, combinations, selections, and/or optimization operations with respect to the prediction(s). In an example embodiment, the machine learning model(s) 314 may be configured to use transformed historical data (as embodied in the parameter expanded data 312) to generate predictions (e.g., of the output data 326) with respect to the set of ordered attribute values and/or other current input parameters.

In the illustrated example, each of the machine learning model(s) 314 is configured based at least in part on the training process 316 and the prediction process 318.

In various embodiments, one or more of the machine learning model(s) 314 may undergo a training process (e.g., represented by the training process 316) using a training data set. The training data set may comprise the raw historical data 308 and other training data 320, which may comprise any data relevant to the prediction task that the machine learning model 314 is configured to perform, including any of the aggregated enterprise data stored in the enterprise data store(s) 306, any portions of the output data 326 generated via one or more of the machine learning model(s) 314 other than that being trained, and/or data from other sources. In one example, the training data set may comprise data indicating historical values (e.g., defined in the raw historical data 308), predicted values (e.g., output via the pseudo-curve model and/or based at least in part on the parameter expanded data 312), actual (e.g., observed) values corresponding to output values representing the predicted values, values representing residuals between the actual and/or historical values and the predicted values, and/or any other values from the aggregated enterprise data associated with and/or cross-referenced with the actual/historical values and/or residuals.

In various embodiments, one or more of the machine learning model(s) 314 may comprise a data object created by using machine learning to learn to perform a given function (e.g., a prediction) through training with the training data set. For example, the training process may formulate a mapping function ƒ from input variables x to discrete output variables y. One or more of the machine learning model(s) 314 may be trained to generate a prediction (e.g., included in the output data 326) by learning from the training data set.

More particularly, in one example, one or more of the machine learning model(s) 314 may undergo the training process using the parameter expanded data 312 in order to formulate a pseudo-curve model comprising a mapping function from an input variable representing an attribute value (e.g., from the set of ordered attribute values) to a discrete output variable representing a predicted value corresponding to the same attribute to which the historical values from the raw historical data 308 also correspond. For example, the pseudo-curve model may comprise a mapping function from an input variable representing a unit price to a discrete output variable representing a predicted demand corresponding to the unit price.

In another example, one or more of the machine learning model(s) 314 may undergo the training process using the pseudo-curve model (and/or any values output by the pseudo-curve model) along with other training data 320 (e.g., from the aggregated enterprise data) in order to identify features from the training data and to determine optimal coefficients representing adjustment or weights to apply with respect to the features in order to produce a target value reflected in the training data set, for example, based on positive and/or negative correlations between the target values and various features of the training data set. The target value for different models may represent elasticity (e.g., of demand with respect to price), actual (e.g., observed) values corresponding to output values representing predicted values, values representing residuals between actual values and predicted values, shifted output values (e.g., output values from the pseudo-curve model shifted upwards or downwards according to additional features), shift values representing amounts to shift (e.g., upwards or downwards) output values, and/or optimized values corresponding to production parameters associated with producing and/or distributing the product(s), to list a few examples. The features may correspond to various domain-specific attributes reflected in the aggregated enterprise data and/or data from other sources. In one example, in the domain of predicting demand for various aerospace parts, the features may correspond to attributes representing quantities of airborne hours for certain related aerospace products (e.g., aircraft), attributes representing promotional operations planned and/or completed with respect to the aerospace parts, attributes representing current phases in a life cycle associated with production of related aerospace products, attributes representing current and/or recent market conditions and/or trends, and/or attributes representing mean or average amounts of time elapsed before failures of certain parts, to list a few examples.

In some embodiments, the training data set (e.g., parameter expanded data 312, other training data 320 including any of the aggregated enterprise data and/or data from other sources, one or more portions of output data 326 produced using machine learning models other than the one being trained) may be input into the training process 316 of the machine learning model(s) 314 to train the model(s) to generate the predictions (e.g., defined in the output data 326). In one example, for one or more of the machine learning model(s) 314, a product of the model training are trained model weights 322 that are used by the prediction process 318 of the machine learning model being trained. In some embodiments, after an initial training, further training data (e.g., subsequently received and/or generated aggregated enterprise data and/or historical data, current market conditions data) may be input to the training process 316 of one or more of the machine learning model(s) 314, periodically or on an on-going basis, to refine and update the model(s).

One or more of the machine learning model(s) 314 may be trained to generate a prediction (e.g., included in the output data 326) based at least in part on an input data set, which may be embodied in and/or comprise the current model input data 324 in some examples.

In some embodiments, an input data set (e.g., embodied in and/or comprising the current model input data 324) for generating a prediction (e.g., included in the output data 326) may comprise a current instance (e.g., reflecting current or up-to-date data at an instance of time when the prediction is being generated) of any of the aggregated enterprise data stored in the enterprise data store(s) 306, portions of the output data 326 produced by one or more of the machine learning model(s) 314 other than that generating the prediction (e.g., output values from the pseudo-demand curve), and/or any other data relevant to the prediction task that the machine learning model 314 is configured to perform. In one example, the input data set (e.g., embodied in and/or comprising the current model input data 324) may comprise data indicative of a period of time (e.g., current or future date, time of year, month, quarter) to which the generated prediction pertains, actual and/or predicted values indicative of economic and/or market conditions associated with a period of time to which the generated prediction pertains, values (e.g., from the aggregated enterprise data stored in the enterprise data store(s) 306) indicative of one or more characteristics of the product(s), enterprise(s), other entities (e.g., purchasing entities), and/or production and/or distribution operation(s) to which the generated prediction pertains. In one example, in the domain of predicting demand for various aerospace parts, the input data set (e.g., embodied in and/or comprising the current model input data 324) may comprise values corresponding to attributes representing quantities of airborne hours for certain related aerospace products (e.g., aircraft), attributes representing promotional operations planned and/or completed with respect to the aerospace parts, attributes representing current phases in a life cycle associated with production of related aerospace products, attributes representing current and/or recent market conditions and/or trends, and/or attributes representing mean or average amounts of time elapsed before failures of certain parts, to list a few examples.

The input data set (e.g., embodied in and/or comprising the current model input data 324) used by the prediction process 318 to generate a prediction using a particular machine learning model of the machine learning model(s) 314 may comprise data analogous to (e.g., containing values corresponding to the same or similar attributes) the training data set used to train the particular machine learning model, with the input data set reflecting current values (e.g., current or up-to-date values corresponding to an instance of time when the prediction is generated, predicted values corresponding to an instance of time to which the prediction pertains) and the training data set reflecting historical values (e.g., values corresponding to an instance of time when the particular machine learning model was trained).

In some embodiments, an input data set (e.g., embodied in and/or comprising the current model input data 324) specific to a particular machine learning model of the machine learning model(s) 314 may be input into the prediction process 318 corresponding to the particular machine learning model, and, in response to receiving the input data set, the prediction process 318 corresponding to the particular machine learning model may be configured to generate output data 326 comprising a prediction corresponding to the prediction task that the particular machine learning model was configured to perform based at least in part on the input data set and/or on the trained model weights 322 corresponding to the particular machine learning model.

In some embodiments, the output data 326 may comprise one or more predictions, each corresponding to a prediction task that a particular machine learning model (of the machine learning model(s) 314) is configured and/or trained to perform. One or more of the predictions of the output data 326 may be generated based at least in part on one or more other predictions included in the output data 326. Moreover, the output data 326 may comprise any data derived from one or more of the predictions generated using the machine learning model(s) 314, for example, as a result of performing (e.g., by the data expansion and prediction system 140) various calculations, transformations, analyses, combinations, selections, and/or optimization operations with respect to the prediction(s).

In some embodiments, the output data 326 may comprise data indicative of predicted elasticity associated with demand for a particular product, predicted demand for a particular product, predicted optimal parameters for determining how current and/or future production, distribution, and/or marketing operations are performed (e.g., predicted optimal unit price for a particular product), and/or predicted effects resulting from changing current parameters to the predicted optimal parameters (e.g., predicted revenue and/or profit, predicted changes to revenue and/or profit), to list a few examples.

In some embodiments, the output data 326 may comprise (e.g., associated with each prediction or set of predictions) data indicative of a level of confidence in an instance of the training data set and/or portion thereof (e.g., parameter expanded data 312, values output by a pseudo-curve model based on the parameter expanded data 312) used to train a corresponding machine learning model and generated (e.g., by the data expansion and prediction system 140) based at least in part on the instance of the training data set and/or portion thereof. Additionally or alternatively, the output data 326 may comprise (e.g., associated with each prediction or set of predictions) data indicative of a level of confidence in an instance of the input data set and/or portion thereof (e.g., parameter expanded data 312, values output by a pseudo-curve model based on the parameter expanded data 312) used to generate a corresponding prediction and generated (e.g., by the data expansion and prediction system 140) based at least in part on the instance of the input data set and/or portion thereof.

In some embodiments, the output data 326 may comprise (e.g., associated with particular predictions such as predicted optimal parameters) data indicative of a determined mismatch between a current parameter for determining how production, distribution, and/or marketing operations are currently performed with respect to a particular product (e.g., current unit price for the particular product) and a predicted optimal parameter that has been generated for that particular product (e.g., predicted optimal unit price for the particular product). In one example, the determined mismatch may be embodied in and/or may be generated based at least in part on one or more calculated quantitative differences between a value associated with the current parameter and a value associated with the predicted optimal parameter, including a calculated difference between a value representing the current parameter and a value representing the predicted optimal parameter and/or a calculated difference between a value representing an effect of the current parameter (e.g., current revenue and/or profit) and/or a value representing a predicted effect resulting from changing the current parameter to the predicted optimal parameter, among other examples.

In some embodiments, the output data 326 may comprise data identifying and/or referencing, with respect to each item of data (e.g., prediction, level of confidence, determined mismatch between current parameters and predicted optimal parameters), an associated object (e.g., product, campaign, objective) to which the item of data pertains. For example, the output data 326 may define each item of data (e.g., prediction, level of confidence, determined mismatch between current parameters and predicted optimal parameters) as being associated with a particular product by attributing each item of data with an identifier associated with the product.

In some embodiments, the data expansion and prediction system 140 may be configured to provide the output data 326 output by the prediction process 318 corresponding to a particular machine learning model of the machine learning model(s) 314 to the training process 316 corresponding to a different machine learning model of the machine learning model(s) 314. For example, output values produced using a pseudo-curve model representing the parameter expanded data 312 may be included in a training data set provided to the training process 316 corresponding to a shifter model configured to shift the output values according to various other features extracted from the training data set and/or input data set associated with the shifter model.

In some embodiments, the data expansion and prediction system 140 may be configured to augment the output data 326 by, for example, performing one or more calculations, transformations, analyses, combinations, selections, and/or optimization operations with respect to items of data included in the output data 326 and adding any data resulting from the one or more calculations, transformations, analyses, combinations, selections, and/or optimization operations to the output data 326.

In some embodiments, the data expansion and prediction system 140 may be configured to store the output data 326, for example, in the one or more data repositories 150 and/or in the enterprise data store(s) 306.

In some embodiments, the data expansion and prediction system 140 may be configured to provide the output data 326 to the results presentation process 328 of the data expansion and prediction system 140 to be presented, for example, as rendered output data 334. More particularly, in some embodiments, the results presentation process 328 may be configured to present the results interface 330, which may be configured to present the output data 326 as the rendered output data 334 (e.g., comprising graphical and/or textual depictions of some or all of the output data 326) and/or receive input (e.g., from and/or based on input received and/or detected via the user device(s) 160) associated with one or more predictions or other items of data in the output data 326, including, for example, results presentation input 332. For example, the results presentation process 328 may be configured to present the results interface 330 within a graphical user interface (GUI) rendered on one or more displays of the user device(s) 160.

The results interface 330 may comprise one or more interactable elements configured to receive input and/or selections (e.g., of the results presentation input 332) that may be used to determine which portions of the output data 326 are presented and/or how (e.g., arrangement, visual characteristics) the output data 326 is presented as the rendered output data 334. The results interface 330 may present the rendered output data 334 in the form of one or more graphical elements representing items of data (e.g., products, predictions associated with the products) from the output data 326, the graphical elements being arranged in positions (e.g., with respect to the GUI and/or relative to other graphical elements) and/or having visual characteristics (e.g., rendered text, color and/or hue, brightness, dimness, boldness) based at least in part on the contents of the output data 326. In some embodiments, the results presentation process 328 may be configured to generate and/or present the results interface 330 based at least in part on data (e.g., aggregated enterprise data) accessed and/or retrieved from the enterprise data store(s) 306 or other sources, including, in one example, combining the accessed and/or retrieved data with portions of the output data 326 corresponding to and/or referencing the same objects (e.g., products) in order to present the rendered output data 334.

In some embodiments, the data expansion and prediction system 140 may be configured to cause the enterprise management system 120 to perform one or more enterprise management operations 336 with respect to the enterprise system(s) 110 based at least in part on the output data 326 and/or the results presentation input 332 received via the results presentation input 332. For example, the data expansion and prediction system 140 may be configured to provide the output data 326 and/or the results presentation input 332 to the enterprise management system 120, which may be configured to, in response to receiving the output data 326 and/or the results presentation input 332, perform the enterprise management operation(s) 336 with respect to the enterprise system(s) 110 based at least in part on the output data 326 and/or the results presentation input 332. In another example, the data expansion and prediction system 140 may be configured to generate instructions and/or control signals based at least in part on the output data 326 and/or the results presentation input 332 and provide the generated instructions and/or control signals to the enterprise management system 120, which may be configured to perform the enterprise management operation(s) 336 with respect to the enterprise system(s) 110 in response to and/or based at least in part on the instructions and/or control signals.

The enterprise management operation(s) 336 may comprise generating and/or updating one or more interfaces (e.g., displayed via the user device(s) 160) based at least in part on the output data 326 and/or controlling operation of the enterprise system(s) 110 based at least in part on the output data 326, to list a few examples. In some embodiments, the enterprise management operation(s) 336 may comprise effecting changes to one or more production parameters that determine how the enterprise system(s) 110 perform and/or facilitate performance of one or more production, distribution, and/or marketing operations with respect to the product(s). For example, the enterprise management operation(s) 336 may comprise effecting a change in a production parameter representing a unit price for a product, the changed production parameter resulting in one or more of the enterprise system(s) 110 (e.g., point of sale system, e-commerce system, contract management system, sales management system, accounting system, customer relationship software system, product management software system, price management system, marketing software system, transaction ledger system) performing operations based on the changed production parameter, including, for example, generating and/or recording subsequent transactions and/or contracts at the new unit price, advertising and/or publishing the new unit price, and/or generating, scheduling, initiating, and/or transmitting communications concerning the new unit price, to list a few examples.

For the purpose of illustration in one example domain, in some scenarios, the products to which the raw historical data 308, parameter expanded data 312, machine learning model(s) 314, current model input data 324, and/or output data 326 pertain may include parts and/or components of aerospace systems such as aircraft.

Moreover, for the purpose of illustration in one example domain, in some scenarios, the set of ordered attribute values (e.g., to which attribute values of the raw historical data 308 correspond) may correspond to a selected attribute that is and/or represents a price such as a unit price for which each unit of a product is listed and/or sold. In this scenario, each of the one or more historical values may be or may represent a determined demand value corresponding to a given price represented by the attribute value corresponding to the historical value. In this case, the parameter expanded data 312 generated from the raw historical data 308 may comprise (for each given price in the ordered set of attribute values) an aggregation of demand at the given price and all prices above the given price. The resulting output data 326 may comprise data representing predicted demand, predicted elasticity, and/or predicted optimal production parameters indicating optimal unit prices (e.g., based on a pseudo-demand model determined from the parameter expanded data 312 and/or other data features).

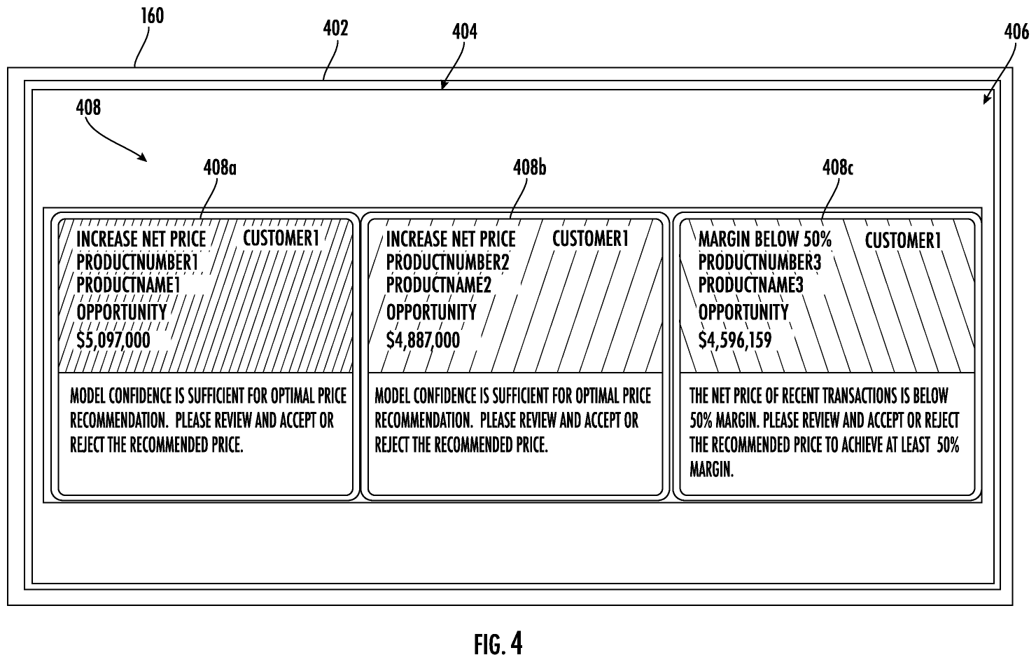

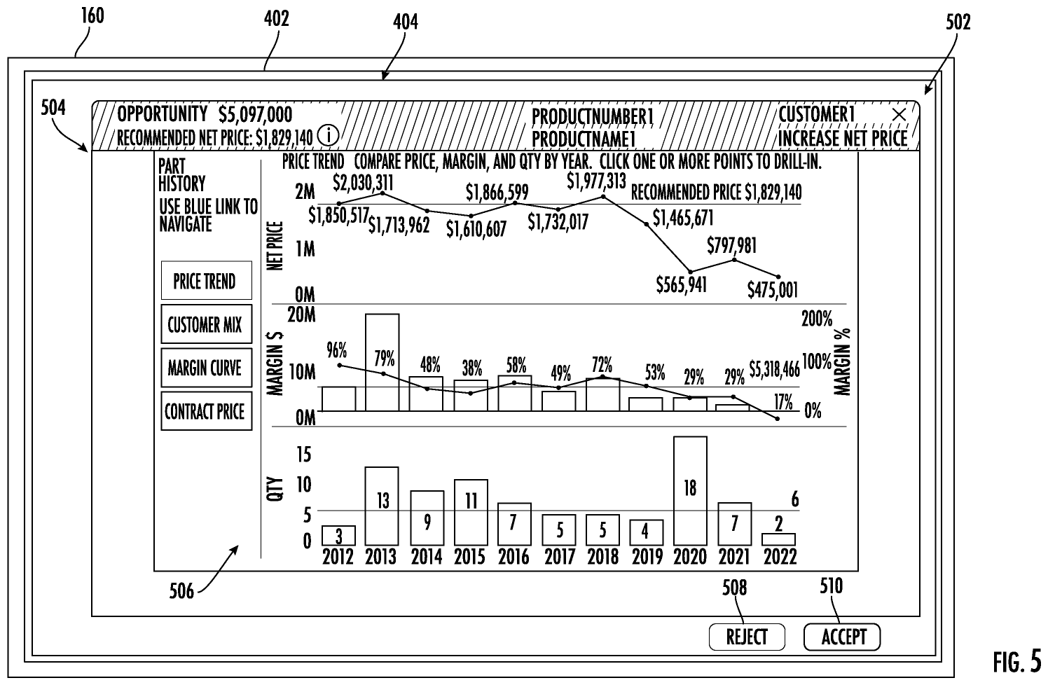

FIGS. 4 and 5 are illustrations of exemplary screens (e.g., of the results interface 330). One or more of these exemplary screens may be presented within a GUI 404 rendered on a display 402 of a computing device such as a user device 160. The GUI 404 may be presented as part of a native application user interface or a user interface of a web application (e.g., rendered via a web browser application). Additionally or alternatively, the GUI 404 may be presented as part of a user interface generated and/or presented by the enterprise management system 120 and/or the enterprise system(s) 110.

In various embodiments, the results interface 330 (e.g., as embodied in the exemplary screens illustrated in FIGS. 4 and 5) may present output data generated by the data expansion and prediction system 140 (e.g., the output data 326) with respect to one or more objects (e.g., products) based at least in part on one or more attributes associated (e.g., in the output data) with the object(s), prediction(s) corresponding to the object(s), and/or training data set(s) used to generate the prediction(s) (e.g., an instance of the parameter expanded data associated with each object), including determined mismatches between current parameter values associated with the object(s) and corresponding predicted values associated with the object(s) and/or levels of confidence associated with instances of the parameter expanded data corresponding to the object(s), to list a few examples. In some embodiments, the results interface 330 (e.g., as embodied in the exemplary screens illustrated in FIGS. 4 and 5) may comprise graphical elements corresponding to, representing, and/or graphically depicting various items of data (e.g., products, predictions associated with the products) from the output data. These graphical elements may be arranged in positions (e.g., with respect to the GUI 404 and/or relative to other graphical elements) and/or may have visual characteristics (e.g., rendered text, color and/or hue, brightness, dimness, boldness) based at least in part on the contents of the output data, including, for example, the one or more attributes (as mentioned and described above) associated with the object(s), prediction(s) corresponding to the object(s), and/or training data set(s) used to generate the prediction(s). Moreover, the results interface 330 (e.g., as embodied in the exemplary screens illustrated in FIGS. 4 and 5) may comprise interactable elements configured to receive (e.g., as user input) input (such as that embodied in the results presentation input 332 as defined and described with respect to FIG. 3).

FIG. 4 is an illustration of an exemplary prediction dashboard screen 406 (e.g., of the results interface 330). In one example, the prediction dashboard screen 406 provides a “dashboard” interface for visualizing, at a high level, various predictions and other items of output data (e.g., output data 326) with respect to one or more products.

More particularly, the prediction dashboard screen 406 comprises dashboard object graphical elements 408, which may be graphically rendered and/or interactable graphical elements, each of which corresponds to a particular product and/or one or more predictions (e.g., generated via the machine learning model(s) 314 and included in the output data 326) associated with the particular product. Each of the dashboard object graphical elements 408 may be arranged in positions and/or may have visual characteristics based at least in part on contents of particular portions of the output data (e.g., output data 326), namely those particular portions specific to the particular product to which the dashboard object graphical element 408 corresponds.

In one example, each of the dashboard graphical elements 408 may comprise visual characteristics such as rendered text identifying, characterizing, and/or describing various items of the corresponding particular portions of the output data pertaining to the graphical element, including the particular product to which the dashboard object graphical element 408 corresponds, a purchasing entity to which the particular product may be sold and/or to which the prediction(s) to which the corresponding prediction(s) pertain, a suggestion of a type of change to a production parameter for determining how the particular product is provided to the corresponding purchasing entity, a numeric value representing a predicted effect resulting from effecting the suggested type of change and/or resulting from changing a current parameter to a predicted optimal parameter (e.g., predicted revenue and/or profit, predicted changes to revenue and/or profit) included in the output data, and/or a level of confidence in an instance of the training data set and/or the input data set (e.g., a level of confidence associated with an instance of the parameter expanded data 312 used in generating the corresponding prediction(s).

In another example, each of the dashboard graphical elements 408 may comprise visual characteristics such as particular colors and/or hues (e.g., green or red) associated with and/or indicative of one or more items of the corresponding particular portions of the output data pertaining to the graphical element. For example, one or more of the dashboard graphical elements 408 may be rendered in a first particular color (e.g., green) associated with and/or indicative of a relatively high level of confidence (e.g., with respect to other prediction(s) and/or product(s)), a relatively high predicted effect resulting from effecting the corresponding suggested type of change and/or resulting from changing a current parameter to a corresponding predicted optimal parameter, and/or a relatively low determined mismatch between a current production parameter and a corresponding predicted optimal production parameter, to list a few examples. In another example, one or more of the dashboard graphical elements may be rendered in a second particular color (e.g., red) associated with and/or indicative of a relatively low level of confidence, a relatively low predicted effect resulting from effecting the corresponding suggested type of change and/or resulting from changing a current parameter to a corresponding predicted optimal parameter, and/or a relatively high determined mismatch between a current production parameter and a corresponding predicted optimal production parameter, to list a few examples.

In another example, each of the dashboard graphical elements 408 may comprise visual characteristics such as brightness or dimness associated with and/or indicative of one or more items of the corresponding particular portions of the output data pertaining to the graphical element. For example, one or more of the dashboard graphical elements 408 may be rendered in a first level of brightness (e.g., relatively bright with respect to levels of brightness of other graphical elements) associated with and/or indicative of a relatively high level of significance of the corresponding prediction(s), which may be determined, for example, based at least in part on combination of one or more features of the corresponding output data, including: a relatively high level of confidence (e.g., with respect to other prediction(s) and/or product(s)), a relatively high predicted effect resulting from effecting the corresponding suggested type of change and/or resulting from changing a current parameter to a corresponding predicted optimal parameter, and/or a relatively high determined mismatch between a current production parameter and a corresponding predicted optimal production parameter, to list a few examples. In another example, one or more of the dashboard graphical elements 408 may be rendered in a second level of brightness (e.g., relatively dim with respect to levels of brightness of other graphical elements) associated with and/or indicative of a relatively low level of significance of the corresponding prediction(s), which may be determined, for example, based at least in part on combination of one or more features of the corresponding output data, including: relatively low level of confidence, a relatively low predicted effect resulting from effecting the corresponding suggested type of change and/or resulting from changing a current parameter to a corresponding predicted optimal parameter, and/or a relatively low determined mismatch between a current production parameter and a corresponding predicted optimal production parameter, to list a few examples.

In another example, each of the dashboard graphical elements 408 may be arranged in particular positions (e.g., with respect to the GUI 404 and/or relative to each other), which particular positions may be determined based at least in part on and/or may be indicative of one or more items of the corresponding particular portions of the output data pertaining to the graphical element. For example, the data expansion and prediction system 140 may be configured to arrange the dashboard object graphical elements 408 in an particular order according to a level of relative significance of the corresponding prediction(s), which may be determined, for example, based at least in part on combination of one or more features of the corresponding output data, including: level of confidence, predicted effect resulting from effecting the corresponding suggested type of change and/or resulting from changing a current parameter to a corresponding predicted optimal parameter, and/or determined mismatch between a current production parameter and a corresponding predicted optimal production parameter, to list a few examples. In another example, the data expansion and prediction system 140 may be configured to generate and present dashboard object graphical elements 408 only for a particular subset of products and/or predictions, which subset may be generated to include only products and/or predictions associated with a level of confidence satisfying a predetermined confidence threshold (e.g., having a sufficiently high level of confidence), only products and/or predictions for which a predicted effect resulting from effecting the corresponding suggested type of change and/or resulting from changing a current parameter to a corresponding predicted optimal parameter satisfies a predetermined predicted effect threshold (e.g., having a sufficiently high predicted effect), only products and/or predictions associated with a determined mismatch between a current production parameter and a corresponding predicted optimal production parameter that satisfies a predetermined mismatch threshold (e.g., having a sufficiently high determined mismatch), and/or only a predetermined quantity of products and/or predictions having the highest (relative to other products and/or predictions) level of confidence, predicted effects, and/or determined mismatch between a current production parameter and a corresponding predicted optimal production parameter, to list a few examples.

Additionally or alternatively, in some embodiments, the data expansion and prediction system 140 may be configured to generate and present dashboard object graphical elements 408 only for a particular subset of products and/or predictions, which subset may be generated to include only those corresponding to particular objects (e.g., products) indicated to be selected objects in user input (e.g., of the results presentation input 332) used to generate the prediction dashboard screen 406.

In the illustrated example, the prediction dashboard screen 406 comprises a first dashboard object graphical element 408a, a second dashboard object graphical element 408b, and a third dashboard object graphical element 408c.

The first dashboard object graphical element 408a is rendered in a green hue or color with a relatively high level of brightness and comprises rendered text identifying the particular product to which the dashboard object graphical element 408a corresponds as “ProductNumber1” and “ProductName1,” identifying a purchasing entity to which the particular product may be sold and/or to which the prediction(s) to which the corresponding prediction(s) pertain as “Customer1,” characterizing a suggestion of a type of change to a production parameter for determining how the particular product is provided to the corresponding purchasing entity as “Increase Net Price,” indicating a numeric value representing a predicted effect resulting from effecting the suggested type of change and/or resulting from changing a current parameter to a predicted optimal parameter as “$5,097,000,” and describing a level of confidence in an instance of the training data set and/or the input data set as being “sufficient for optimal price recommendation.”

The second dashboard object graphical element 408a is rendered in a green hue or color with a relatively low level of brightness and comprises rendered text identifying the particular product to which the dashboard object graphical element 408b corresponds as “ProductNumber2” and “ProductName2,” identifying a purchasing entity to which the particular product may be sold and/or to which the prediction(s) to which the corresponding prediction(s) pertain as “Customer1,” characterizing a suggestion of a type of change to a production parameter for determining how the particular product is provided to the corresponding purchasing entity as “Increase Net Price,” indicating a numeric value representing a predicted effect resulting from effecting the suggested type of change and/or resulting from changing a current parameter to a predicted optimal parameter as “$4,887,000,” and describing a level of confidence in an instance of the training data set and/or the input data set as being “sufficient for optimal price recommendation.”

The third dashboard object graphical element 408c is rendered in a red hue or color with a relatively low level of brightness and comprises rendered text identifying the particular product to which the dashboard object graphical element 408c corresponds as “ProductNumber3” and “ProductName3.” identifying a purchasing entity to which the particular product may be sold and/or to which the prediction(s) to which the corresponding prediction(s) pertain as “Customer1,” characterizing a suggestion of a type of change to a production parameter for determining how the particular product is provided to the corresponding purchasing entity as “Margin below 50%,” and indicating a numeric value representing a predicted effect resulting from effecting the suggested type of change and/or resulting from changing a current parameter to a predicted optimal parameter as “$4,596,159.”

In some embodiments, each of the dashboard object graphical elements 408 may be interactable graphical elements configured to receive (e.g., via detected interactions with the dashboard object graphical elements 408) user input (e.g., embodied in, comprising, and/or comprised by the results presentation input 332). For example, each of the dashboard object graphical elements 408 may be selectable such that selection of one of the dashboard object graphical elements 408 is indicative of a selection of the product(s) and/or prediction(s) corresponding to the selected dashboard object graphical element 408. In response to selection of a dashboard object graphical element 408, the data expansion and prediction system 140 may be configured to update the results interface 330 and/or the prediction dashboard screen 406 to present a more detailed view of the particular portions of the output data (e.g., output data 326) that are associated with the product(s) and/or prediction(s) corresponding to the selected dashboard object graphical element 408.

FIG. 5 is an illustration of an exemplary prediction details screen 502 (e.g., of the results interface 330). In one example, the prediction details screen 502 provides a “drilled down” interface for visualizing predictions and other items of output data (e.g., output data 326) with respect to a particular, selected product. In some embodiments, the prediction details screen 502 may correspond to a particular product that was selected via the prediction dashboard screen 406, and, in one example, the data expansion and prediction system 140 may be configured to, in response to selection of a dashboard object graphical element 408 corresponding to a particular product on the prediction dashboard screen 406, update the GUI 404 to present an instance of the prediction details screen 406 specific to the particular product to which the selected dashboard object graphical element 408 corresponds.

In various embodiments, the prediction details screen 502 may comprise a header pane 504, a details pane 506, a reject button 508, and an accept button 510.

The header pane 504 may be a region or portion of the GUI 502 within which higher-level items of output data (e.g., output data 326) specific to the particular product and/or prediction(s) to which a current instance of the prediction details screen 502 corresponds are indicated, including rendered text identifying, characterizing, and/or describing the particular product to which the current instance of the prediction details screen 502 corresponds, a purchasing entity to which the particular product may be sold and/or to which the prediction(s) to which the corresponding prediction(s) pertain, a suggestion of a suggestion of a type of change to a production parameter for determining how the particular product is provided to the corresponding purchasing entity, a numeric value representing a predicted effect resulting from effecting the suggested type of change and/or resulting from changing a current parameter to a predicted optimal parameter (e.g., predicted revenue and/or profit, predicted changes to revenue and/or profit) included in the output data, and/or a numeric value representing and/or derived from a corresponding predicted optimal parameter.

The details pane 506 may be a region or portion of the GUI 502 within which lower-level (e.g., more “drilled down” or granular) items of output data (e.g., output data 326) specific to the particular product and/or prediction(s) to which a current instance of the prediction details screen 502 corresponds are indicated, including one or more rendered charts and/or graphs representing and/or derived from various aspects of the corresponding output data (e.g., predictions) possibly combined with historical data (e.g., from the aggregated enterprise data) corresponding to the particular product. In the illustrated example, the details pane 506 comprises three rendered graphs respectively depicting, over time, historical net price data, margin data, and demand data associated with the particular product, each of the rendered graphs comprising graphical elements (e.g., overlaid over the rendered graphs) indicating predicted values and/or predicted optimal parameters (e.g., from the output data 326) with respect to the graphically depicted historical data.

The reject button 508 and the accept button 510 may be interactable graphical elements configured to receive (e.g., via detected interactions with the buttons 508, 510) user input (e.g., embodied in, comprising, and/or comprised by the results presentation input 332). In various embodiments, each of the buttons 508, 510 may be selectable such that selection of one of the button is indicative of a confirmation of or rejection of the predicted values and/or predicted optimal parameters presented in the header pane 504 and the details pane 506. For example, in response to selection of the reject button 508, the data expansion and prediction system 140 may be configured to retain a current value for the parameter to which the predicted optimal parameter corresponds along with possibly updating the GUI 404 to clear the current instance of the prediction details screen 502, replace the current instance of the prediction details screen 502 with the prediction dashboard screen 406, and/or update the prediction dashboard screen 406 to remove the dashboard object graphical element 408 corresponding to the product(s) and/or prediction(s) to which the rejected predicted optimal parameters pertain. In another example, in response to selection of the accept button 510, the data expansion and prediction system 140 may be configured to effect a change to a current value for the parameter to which the predicted optimal parameter corresponds by, for example, updating the current parameter to the predicted optimal parameter (e.g., by updating a stored value corresponding to the current parameter and accessible by the enterprise management system 120 and/or enterprise system(s) 110 that operate based on the parameter with a new value corresponding to the predicted optimal parameter) and/or generating and/or transmitting to the enterprise management system 120 and/or one or more of the enterprise system(s) 110 instructions and/or control signals effecting the change of the current value for the parameter to a new value corresponding to the predicted optimal parameter, to list a few examples.

Having described example systems and/or apparatuses of the present disclosure, example flowcharts including various operations performed by the apparatuses and/or systems described herein will now be discussed. It should be appreciated that each of the flowcharts depicts an example computer-implemented process that may be performed by one or more of the apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur in-between one or more blocks of another process, before one or more blocks of another process, and/or otherwise operates as a sub-process of a second process. Additionally or alternatively, any of the processes may include some or all of the steps described and/or depicted, including one or more optional operational blocks in some embodiments. With respect to the flowcharts discussed below, one or more of the depicted blocks may be optional in some, or all, embodiments of the disclosure. Similarly, it should be appreciated that one or more of the operations of each flowchart may be combinable, replaceable, and/or otherwise altered as described herein.

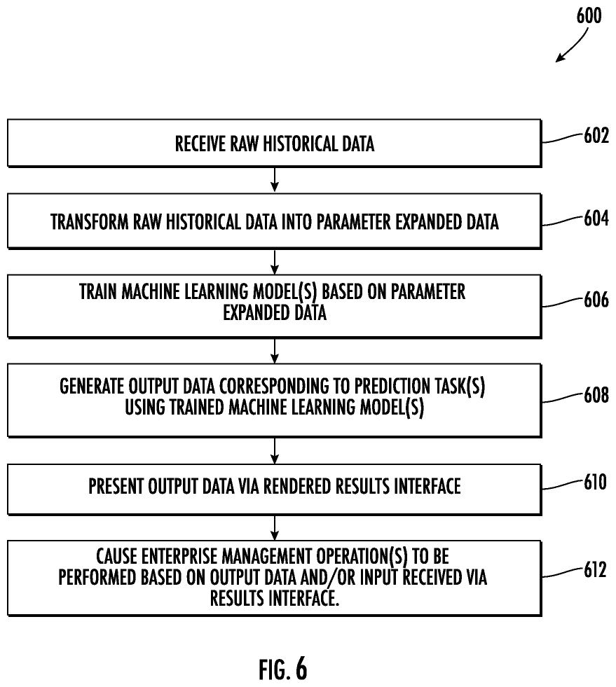

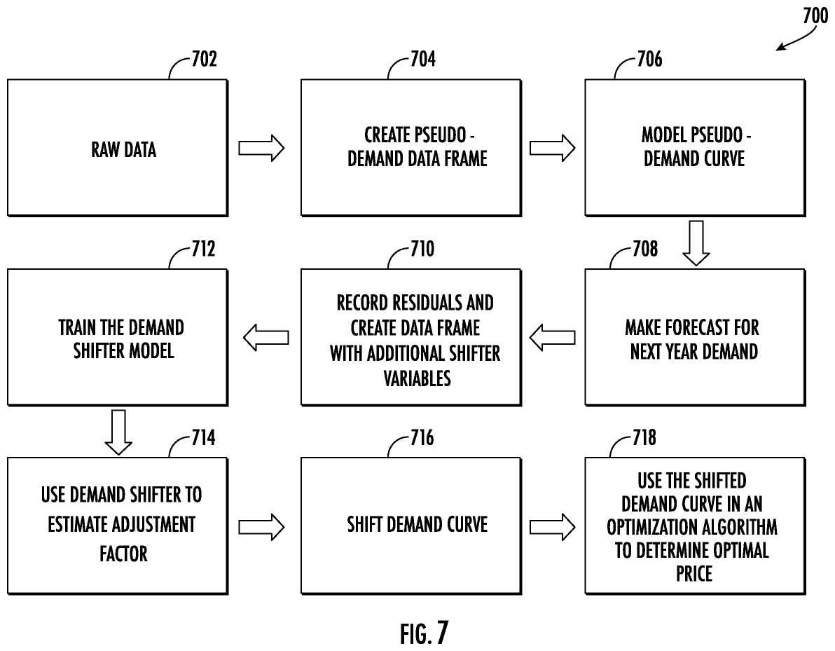

FIGS. 6 and 7 illustrate flowcharts including operational blocks of example processes in accordance with at least some example embodiments of the present disclosure. In some embodiments, the computer-implemented processes of FIGS. 6 and 7 are embodied by computer program code stored on a non-transitory computer-readable medium of a computer program product configured for execution to perform the computer-implemented method. Alternatively or additionally, in some embodiments, the example processes of FIGS. 6 and 7 are performed by one or more specially configured computing devices, such as the specially configured apparatus 200 (e.g., via data intake circuitry 212, AI and machine learning circuitry 210, data output circuitry 214, and/or data transformation circuitry 216). In this regard, in some such embodiments, the apparatus 200 is specially configured by computer program instructions stored thereon, for example in the memory 204 and/or another component depicted and/or described herein, and/or otherwise accessible to the apparatus 200, for performing the operations as depicted and described with respect to the example processes of FIGS. 6 and 7. In some embodiments, the specially configured apparatus 200 includes and/or otherwise is in communication with one or more external apparatuses, systems, devices, and/or the like, to perform one or more of the operations as depicted and described. While the operational blocks of the example processes are depicted in FIGS. 6 and 7 in a particular order, this should not be understood as requiring that such operations be performed in the particular order shown or in sequential order, or that all illustrated operations be performed.

FIG. 6 illustrates a flowchart including operational blocks of an example process 600 for transforming raw historical data to parameter expanded data and generating predictions based on the transformed data, in accordance with at least some example embodiments of the present disclosure.

The process 600 begins at operation 602, at which an apparatus (such as, but not limited to, the apparatus 200 or circuitry thereof as described above in connection with FIG. 2) receives raw historical data identifying at least one historical value corresponding to at least one attribute value of a set of ordered attribute values. The set of ordered attribute values referenced with respect to operation 602 corresponds to a selected attribute. In various embodiments, the raw historical data received at operation 602 may correspond to and/or comprise the raw historical data 308 as defined and described with respect to FIG. 3, and receiving the raw historical data at operation 602 may comprise some or all of the analogous functionality attributed to the data transformation process 310 as described with respect to FIG. 3. Additionally or alternatively, the set of ordered attribute values and/or the selected attribute referenced with respect to operation 602 may be as defined and described with respect to FIG. 3.

At operation 604 of the process 600, an apparatus (such as, but not limited to, the apparatus 200 or circuitry thereof described above in connection with FIG. 2) transforms the raw historical data received at operation 602 into parameter expanded data corresponding to the selected attribute by at least, for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value. In some embodiments, the parameter expanded data generated at operation 604 may be associated with a prediction task to be performed via at least one machine learning model and/or may comprise aggregated data associated with at least a subset of the set of ordered attribute values. In various embodiments, the parameter expanded data into which the raw historical data is transformed at operation 604 may correspond to and/or comprise the parameter expanded data 312 as defined and described with respect to FIG. 3, and transforming the raw historical data into the parameter expanded data at operation 604 may comprise some or all of the analogous functionality (for generating the parameter expanded data 312) attributed to the data transformation process 310, as described with respect to FIG. 3. Additionally or alternatively, the machine learning model(s) referenced with respect to operation 604 may correspond to and/or comprise the machine learning model(s) 314 as defined and described with respect to FIG. 3.

At operation 606 of the process 600, an apparatus (such as, but not limited to, the apparatus 200 or circuitry thereof described above in connection with FIG. 2) trains the machine learning model(s) (referenced with respect to operation 602) based at least in part on the parameter expanded data (generated at operation 604). In various embodiments, training the machine learning model(s) at operation 606 may comprise some or all of the analogous functionality attributed to the training process 316 as described with respect to FIG. 3.

At operation 608 of the process 600, an apparatus (such as, but not limited to, the apparatus 200 or circuitry thereof described above in connection with FIG. 2) generates output data corresponding to the prediction task (referenced with respect to operation 602) using the trained at least one machine learning model that were trained at operation 606. In various embodiments, the output data generated at operation 608 may correspond to and/or comprise the output data 326 as defined and described with respect to FIG. 3, and generating the output data at operation 608 may comprise some or all of the analogous functionality attributed to the prediction process 318 and/or the data expansion and prediction system 140 as described with respect to FIG. 3.

At operation 610 of the process 600, an apparatus (such as, but not limited to, the apparatus 200 or circuitry thereof described above in connection with FIG. 2) presents the output data generated at operation 608 by causing rendering of a results interface that presents the generated output data. In various embodiments, the output data presented at operation 610 may correspond to and/or comprise the rendered output data 334 as defined and described with respect to FIG. 3, the results interface rendered at operation 610 may correspond to and/or comprise the results interface 330 as defined and described with respect to FIG. 3, and presenting the output data and/or rendering the results interface at operation 610 may comprise some or all of the analogous functionality attributed to the results presentation process 328 as described with respect to FIG. 3. Additionally or alternatively, the results interface rendered at operation 610 may correspond to and/or comprise the prediction dashboard screen 406 as illustrated, defined, and described with respect to FIG. 4 and/or the prediction details screen 502 as illustrated, defined, and described with respect to FIG. 5, and rendering the results interface at operation 610 may comprise presenting, rendering, and/or displaying the prediction dashboard screen 406 and/or the prediction details screen 502.

At operation 612 of the process 600, an apparatus (such as, but not limited to, the apparatus 200 or circuitry thereof described above in connection with FIG. 2) causes one or more enterprise management operations to be performed based at least in part on the output data generated at operation 608 and/or based at least in part on input received via the results interface rendered at operation 610. In various embodiments, the enterprise management operation(s) caused to be performed at operation 612 may correspond to and/or comprise one or more of the enterprise management operation(s) 336 as defined and described with respect to FIG. 3, and causing the enterprise management operation(s) to be performed at operation 612 may comprise some or all of the analogous functionality attributed to the data expansion and prediction system 140 as described with respect to FIG. 3. Additionally or alternatively, the input received via the results interface as referenced with respect to operation 612 may correspond to and/or comprise the results presentation input 332 as defined and described with respect to FIG. 3 and/or any of the input received via the prediction dashboard screen 406 as described with respect to FIG. 4 and/or the prediction details screen 502 as described with respect to FIG. 5.

FIG. 7 illustrates a flowchart including operational blocks of an example process 700 for transforming raw historical data, creating a pseudo-curve model (e.g., representing predicted demand at various unit prices) based on the transformed raw historical data, and generating additional predictions using the pseudo-curve model, in accordance with at least some example embodiments of the present disclosure.

The process 700 begins at operation 702, at which an apparatus (such as, but not limited to, the apparatus 200 or circuitry thereof as described above in connection with FIG. 2) receives raw historical data. In various embodiment, the raw historical data received at operation 702 may comprise transaction data defining one or more historical demand values each representing a demand or quantity of units of a product that was purchased at a corresponding price attribute value representing a unit price. In some embodiments, the raw historical data received at operation 702 may correspond to, may comprise, and/or may be comprised by the raw historical data received at operation 602 of the process 600 as defined and described with respect to FIG. 6, and receiving the raw historical data at operation 702 may correspond to, may comprise, and/or may be comprised by the functionality of operation 602 of the process 600 as defined and described with respect to FIG. 6.

At operation 704 of the process 700, an apparatus (such as, but not limited to, the apparatus 200 or circuitry thereof described above in connection with FIG. 2) creates a pseudo-demand data frame based at least in part on the raw historical data received at operation 702. In various embodiments, the pseudo-demand data frame created at operation 704 may define for each particular price attribute value (e.g., from a set of ordered price attribute values representing a domain of possible unit prices) an aggregated demand value determined as a sum of all historical demand values corresponding to a price attribute value that is equal to or greater than the particular price attribute value. Put another way, the pseudo-demand data frame created at operation 704 may define demand at every possible price point as the sum of demand at all equal or higher price points as indicated in the raw historical data. In some embodiments, the pseudo-demand data frame created at operation 704 may correspond to, may comprise, and/or may be comprised by the parameter expanded data generated at operation 604 of the process 600 as defined and described with respect to FIG. 6, and creating the pseudo-demand data frame at operation 704 may correspond to, may comprise, and/or may be comprised by the functionality of operation 604 of the process 600 as defined and described with respect to FIG. 6.

At operation 706 of the process 700, an apparatus (such as, but not limited to, the apparatus 200 or circuitry thereof described above in connection with FIG. 2) models a pseudo-demand curve based at least in part on and/or representing the pseudo-demand data frame created at operation 704. In various embodiments, the pseudo-demand curve may be modeled by formulating a pseudo-demand model (e.g., via regression analysis) comprising a mapping function from an input variable representing a price attribute value (e.g., from the ordered set of price attribute values) to a discrete output variable representing a predicted demand value corresponding to the price attribute value represented by the input variable. In some embodiments, the pseudo-demand model generated at operation 706 may correspond to, may comprise, and/or may be comprised by the one or more machine learning models referenced with respect to the process 600 as described with respect to FIG. 6, and modeling the pseudo-demand curve and/or formulating the pseudo-demand model at operation 706 may correspond to, may comprise, and/or may be comprised by the machine learning model training functionality of operation 606 of the process 600 as defined and described with respect to FIG. 6.

At operation 708 of the process 700, an apparatus (such as, but not limited to, the apparatus 200 or circuitry thereof described above in connection with FIG. 2) generates a demand forecast representing demand corresponding to a particular period of time such as the next year. In various embodiments, the demand forecast generated at operation 708 may be generated using the pseudo-demand model generated at operation 706, for example, by inputting one or more predicted prices (e.g., planned for the next year, estimated for the next year) into the pseudo-demand model and generating the demand forecast to comprise the resulting demand values output by the pseudo-demand model.

At operation 710 of the process 700, an apparatus (such as, but not limited to, the apparatus 200 or circuitry thereof described above in connection with FIG. 2) records residuals with respect to the demand forecast generated at operation 708 and generates a shifter data frame comprising a combination of the demand forecast, the residuals recorded with respect to the demand forecast, and/or one or more additional shifter variables corresponding to various attributes associated with the recorded residuals. In various embodiments, the recorded residuals may comprise one or more historical demand values representing and/or derived from actual, observed demand (e.g., quantities of units of the product that sold) over the particular period of time to which the demand forecast corresponds. In one example, the historical demand value(s) of the recorded residuals may represent a quantitative difference between predicted demand at various unit prices and/or points in time and the actual, observed demand at the same unit prices and/or points in time. Moreover, in various embodiments, the additional shifter variable(s) may comprise one or more historical values representing actual, observed (e.g., market) conditions and/or attributes corresponding to each of the recorded residuals. In one example, in the domain of predicting demand for various aerospace parts, the additional shifter variable(s) may correspond to attributes representing quantities of airborne hours for certain related aerospace products (e.g., aircraft), attributes representing promotional operations planned and/or completed with respect to the aerospace parts, attributes representing current phases in a life cycle associated with production of related aerospace products, attributes representing current and/or recent market conditions and/or trends, and/or attributes representing mean or average amounts of time elapsed before failures of certain parts, to list a few examples.

Additionally or alternatively, the recorded residuals and/or shifter data frame generated at operation 710 may correspond to and/or may be comprised by a training data set used to train one of the machine learning model(s) 314 as defined and described with respect to FIG. 3. Additionally or alternatively, the recorded residuals and/or shifter data frame generated at operation 710 may correspond to and/or may be comprised by a training data set used to train one of the machine learning model(s) referenced with respect to, for example, operation 606 of the process 600 as described with respect to FIG. 6.

At operation 712 of the process 700, an apparatus (such as, but not limited to, the apparatus 200 or circuitry thereof described above in connection with FIG. 2) trains a demand shifter model based at least in part on the recorded residuals and/or shifter data frame generated at operation 710. In one example, the demand shifter model may be trained at operation 712 by identifying features from the shifter data frame from among the additional shifter variable(s), determining optimal coefficients representing adjustments or weights to apply with respect to the features in order to produce target values reflected in the shifter data frame (namely the recorded residuals) based on positive and/or negative correlations between the recorded residuals and the additional shifter variable(s), and formulating a mapping function (e.g., of the demand shifter model) from input variables corresponding to the additional shifter variable(s) of the shifter data frame to discrete output variables corresponding to an adjustment factor representing an amount to adjust (e.g., upwards or downwards) the pseudo-demand curve modeled at operation 706 and/or the predicted demand values output by the pseudo-demand model generated at operation 706. Additionally or alternatively, the demand shifter model trained at operation 712 may correspond to and/or may be comprised by the machine learning model(s) trained at operation 606 of the process 600 as described with respect to FIG. 6, and training the demand shifter model at operation 712 may correspond to and/or may be comprised by the functionality of operation 606 of the process 600 as defined and described with respect to FIG. 6. Additionally or alternatively, the demand shifter model trained at operation 712 may correspond to and/or may be comprised by the machine learning model(s) 314 as defined and described with respect to FIG. 3, and training the demand shifter model at operation 712 may comprise some or all of the analogous functionality attributed to the training process 316 as described with respect to FIG. 3.

At operation 714 of the process 700, an apparatus (such as, but not limited to, the apparatus 200 or circuitry thereof described above in connection with FIG. 2) uses the demand shifter model trained at operation 712 to generate an estimated adjustment factor representing an amount to adjust (e.g., upwards or downwards) the pseudo-demand curve modeled at operation 706 and/or the predicted demand values output by the pseudo-demand model generated at operation 706. In one example, the estimated adjustment factor may be generated at operation 714 by inputting into the trained shifter model current model input data comprising one or more current values corresponding to each of the input variables of the trained shifter model and generating the estimated adjustment factor to comprise any resulting values output by the demand shifter model. The current value(s) of the current model input data input into the trained shifter model may reflect and/or characterize, for example, current conditions at an instance of time when the estimated adjustment factor is being generated or predicted conditions at a future instance of time to which the present prediction task pertains.

At operation 716 of the process 700, an apparatus (such as, but not limited to, the apparatus 200 or circuitry thereof described above in connection with FIG. 2) generates a shifted demand curve based at least in part on the estimated adjustment factor generated at operation 714 and the pseudo-demand curve and/or pseudo-demand model generated at operation 706. In one example, the shifted demand curve may represent predicted demand at each unit price from the set of ordered price attribute values and/or may comprise, for each unit price, a shifted predicted demand value determined as a corresponding original (e.g., unshifted) predicted demand value from the pseudo-demand curve adjusted upwards or downwards according to the estimated adjustment factor.

At operation 718 of the process 700, an apparatus (such as, but not limited to, the apparatus 200 or circuitry thereof described above in connection with FIG. 2) generates a predicted optimal price parameter (e.g., representing a predicted optimal unit price) based at least in part on the shifted demand curve generated at operation 716, for example, by inputting the shifted demand curve into an optimization algorithm configured to output the predicted optimal price parameter based on analysis of the shifted demand curve.

In various embodiments, the demand forecast generated at operation 708, the estimated adjustment factor generated at operation 714, the shifted demand curve generated at operation 716, and/or the predicted optimal price parameter generated at operation 718 may be comprised by the output data generated at operation 610 of the process 600 as described with respect to FIG. 6, and generating the demand forecast at operation 708, the estimated adjustment factor at operation 714, the shifted demand curve at operation 716, and/or the predicted optimal price parameter at operation 718 may correspond to and/or may be comprised by the functionality of operation 608 of the process 600 as defined and described with respect to FIG. 6.

Additionally or alternatively, the demand forecast generated at operation 708, the estimated adjustment factor generated at operation 714, the shifted demand curve generated at operation 716, and/or the predicted optimal price parameter generated at operation 718 may be comprised by the output data 326 as defined and described with respect to FIG. 3, and generating the demand forecast at operation 708, the estimated adjustment factor at operation 714, the shifted demand curve at operation 716, and/or the predicted optimal price parameter at operation 718 may comprise some or all of the analogous functionality attributed to the prediction process 318 and/or the data expansion and prediction system 140 as described with respect to FIG. 3.

Additionally or alternatively, the demand forecast generated at operation 708, the estimated adjustment factor generated at operation 714, the shifted demand curve generated at operation 716, and/or the predicted optimal price parameter generated at operation 718 may be comprised by the output data presented at operation 610 as described with respect to FIG. 6 and/or the rendered output data 334 presented via the results interface 330 as defined and described with respect to FIG. 3, including the prediction dashboard screen 406 as described with respect to FIG. 4 and/or the prediction details screen 502 as described with respect to FIG. 5.

Additionally or alternatively, the demand forecast generated at operation 708, the estimated adjustment factor generated at operation 714, the shifted demand curve generated at operation 716, and/or the predicted optimal price parameter generated at operation 718 may be comprised by the output data based upon which enterprise management operation(s) are caused to be performed at operation 612 of the process 600 as described with respect to FIG. 6. For example, the enterprise management operation(s) may comprise effecting a change in a production parameter representing a unit price for a product based at least in part on the predicted optimal price parameter generated at operation 718, the changed production parameter resulting in one or more of the enterprise system(s) 110 (e.g., point of sale system, e-commerce system, contract management system, sales management system, accounting system, customer relationship software system, product management software system, price management system, marketing software system, transaction ledger system) performing operations based on the changed production parameter, including, for example, generating and/or recording subsequent transactions and/or contracts at the new unit price, advertising and/or publishing the new unit price, and/or generating, scheduling, initiating, and/or transmitting communications concerning the new unit price, to list a few examples.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. An apparatus comprising at least one processor and at least one non-transitory memory comprising program code stored thereon, wherein the at least one non-transitory memory and the program code are configured to, with the at least one processor, cause the apparatus to at least:
receive raw historical data identifying at least one historical value corresponding to at least one attribute value of a set of ordered attribute values, wherein the set of ordered attribute values corresponds to a selected attribute;
transform the raw historical data into parameter expanded data corresponding to the selected attribute, wherein the parameter expanded data is associated with a prediction task to be performed via at least one machine learning model and comprises aggregated data associated with at least a subset of the set of ordered attribute values, by at least:
for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value;
train the at least one machine learning model based at least in part on the parameter expanded data; and
generate output data corresponding to the prediction task using the trained at least one machine learning model.

2. The apparatus of claim 1, wherein the at least one non-transitory memory and the program code are configured to, with the at least one processor, further cause the apparatus to at least:
cause performance of at least one enterprise management operations based at least in part on the generated output data.

3. The apparatus of claim 1, wherein the at least one non-transitory memory and the program code are configured to, with the at least one processor, further cause the apparatus to at least:
cause rendering of a results interface that presents the generated output data.

4. The apparatus of claim 3, wherein the results interface presents the output data with respect to a plurality of objects based at least in part on, for each particular object of the plurality of objects, a determined mismatch between a current parameter value associated with the particular object corresponding to the selected attribute and a corresponding predicted value associated with the particular object in the output data corresponding to the selected attribute.

5. The apparatus of claim 3, wherein the results interface presents the output data with respect to a plurality of objects based at least in part on, for each particular object of the plurality of objects, a level of confidence associated with an instance of the parameter expanded data corresponding to the particular object.

6. The apparatus of claim 1, wherein training the at least one machine learning model based at least in part on the parameter expanded data comprises generating a pseudo-curve model that represents the parameter expanded data and training the at least one machine learning model based at least in part on the pseudo-curve model.

7. The apparatus of claim 6, wherein training the at least one machine learning model based at least in part on the parameter expanded data comprises generating and training, based at least in part on the pseudo-curve model, an elasticity model expressing elasticity output values with respect to input values corresponding to the selected attribute, wherein the output data comprises the elasticity output values.

8. The apparatus of claim 6, wherein training the at least one machine learning model based at least in part on the parameter expanded data comprises generating and training, based at least in part on the pseudo-curve model, a shifter model expressing shifted output values with respect to input values corresponding to the selected attribute and with respect to at least one additional variable, wherein the output data comprises the shifted output values.

9. The apparatus of claim 1, wherein generating the output data corresponding to the prediction task comprises performing at least one optimization operation using at least one optimization algorithm with respect to at least a portion of the output data generated by the trained at least one machine learning model, wherein the output data comprises results of the at least one optimization operations.

10. The apparatus of claim 1, wherein the selected attribute represents a price attribute, each historical value of the at least one historical value representing a determined demand value corresponding to a particular price value represented by the corresponding attribute value, the parameter expanded data comprises an aggregation of demand at a given price and all prices greater than the given price, and the output data represents predicted demand, predicted elasticity, and/or determined optimal pricing based on a pseudo-demand model determined based at least in part on the parameter expanded data.

11. A computer-implemented method comprising:
receiving raw historical data identifying at least one historical value corresponding to at least one attribute value of a set of ordered attribute values, wherein the set of ordered attribute values corresponds to a selected attribute;
transforming the raw historical data into parameter expanded data corresponding to the selected attribute, wherein the parameter expanded data is associated with a prediction task to be performed via at least one machine learning model and comprises aggregated data associated with at least a subset of the set of ordered attribute values, by at least:
for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value;
training the at least one machine learning model based at least in part on the parameter expanded data; and
generating output data corresponding to the prediction task using the trained at least one machine learning model.

12. The method of claim 11, further comprising causing performance of at least one enterprise management operations based at least in part on the generated output data.

13. The method of claim 11, further comprising causing rendering of a results interface that presents the generated output data.

14. The method of claim 13, wherein the results interface presents the output data with respect to a plurality of objects based at least in part on, for each particular object of the plurality of objects, a determined mismatch between a current parameter value associated with the particular object corresponding to the selected attribute and a corresponding predicted value associated with the particular object in the output data corresponding to the selected attribute.

15. The method of claim 13, wherein the results interface presents the output data with respect to a plurality of objects based at least in part on, for each particular object of the plurality of objects, a level of confidence associated with an instance of the parameter expanded data corresponding to the particular object.

16. The method of claim 11, wherein training the at least one machine learning model based at least in part on the parameter expanded data comprises generating a pseudo-curve model that represents the parameter expanded data and training the at least one machine learning model based at least in part on the pseudo-curve model.

17. The method of claim 16, wherein training the at least one machine learning model based at least in part on the parameter expanded data comprises generating and training, based at least in part on the pseudo-curve model, an elasticity model expressing elasticity output values with respect to input values corresponding to the selected attribute, wherein the output data comprises the elasticity output values.

18. The method of claim 16, wherein training the at least one machine learning model based at least in part on the parameter expanded data comprises generating and training, based at least in part on the pseudo-curve model, a shifter model expressing shifted output values with respect to input values corresponding to the selected attribute and with respect to at least one additional variable, wherein the output data comprises the shifted output values.

19. The method of claim 11, wherein generating the output data corresponding to the prediction task comprises performing at least one optimization operation using at least one optimization algorithm with respect to at least a portion of the output data generated by the trained at least one machine learning model, wherein the output data comprises results of the at least one optimization operations.

20. A computer program product comprising at least one non-transitory computer-readable storage medium having computer-readable program code portions stored therein, the computer-readable program code portions comprising an executable portion configured to:
receive raw historical data identifying at least one historical value corresponding to at least one attribute value of a set of ordered attribute values, wherein the set of ordered attribute values corresponds to a selected attribute;
transform the raw historical data into parameter expanded data corresponding to the selected attribute, wherein the parameter expanded data is associated with a prediction task to be performed via at least one machine learning model and comprises aggregated data associated with at least a subset of the set of ordered attribute values, by at least:
for each particular attribute value of the set of ordered attribute values, aggregating (i) each historical value that corresponds to the particular attribute value from the at least one historical value, and (ii) each historical value that corresponds to an attribute value that is greater than the particular attribute value from the at least one historical value;
train the at least one machine learning model based at least in part on the parameter expanded data; and
generate output data corresponding to the prediction task using the trained at least one machine learning model.
